(19) United States
(12) Patent Application Publication
(10) Pub. No.: US 2017/0241551 A1
(43) Pub. Date: Aug. 24, 2017

(54) Gate Valve

(71) Applicant: Ulefos Esco AS, Kongsberg (NO)

(72) Inventor: Anders Nygård, Kongsberg (NO)

(73) Assignee: Ulefos Esco AS, Kongsberg (NO)

(21) Appl. No.: 15/513,912

(22) PCT Filed: Sep. 16, 2015
(86) PCT No.: PCT/NO2015/050162

§ 371 Date: Mar. 23, 2017

(30) Foreign Application Priority Data
Oct. 9, 2014 (NO) 20141212

(51) Int. Cl. F16K 3/02; F16K 27/04

(52) U.S. Cl. CPC F16K 3/0272; F16K 27/044

(57) ABSTRACT

A gate valve comprising a valve body (2) provided with an inlet opening (3), an outlet opening (4) and a fluid flow channel (5) connecting the inlet (3) and the outlet (4) openings. The valve body (2) further comprises a control body (6) extending laterally to the fluid flow channel (5) and having an outer opening (7). Also, the gate valve (1) comprises a gate member (8) movable within the control body (6) back and forth through the outer opening (7), between an open position and a closed position, for controlling fluid flow through the flow channel (5). The gate valve (1) further comprises a housing (12) comprising an inlet member (13), an outlet member (14), a top member (15), and a bottom member (16). The gate valve comprises three independent sealing zones (A, B, C) for sealing between housing (12) and valve body (2), wherein the first sealing zone is provided between the valve body (2) and the top member (15), the second sealing zone is provided between the valve body (2) and the inlet member (13), and the third sealing zone is provided between the valve body (2) and the outlet member (14).

### TECHNICAL FIELD

The invention relates to gate valves, and more specifically to gate valves comprising a metal housing, and a valve body with a gate member movable within the valve body between an open and a closed position for controlling fluid flow through the gate valve.

### BACKGROUND

One known gate valve is described in U.S. Pat. No. 6,942,194B2. The gate valve comprises a valve body provided with an inlet opening, an outlet opening and a fluid flow channel connecting the inlet and the outlet openings. The valve body further comprises a control body extending laterally to the fluid flow channel and having an outer opening. Also, the gate valve comprises a gate member movable within the control body back and forth through the outer opening, between an open position and a closed position, for controlling fluid flow through the flow channel.

The valve body comprises a rigid body permanently connected to one or more less rigid bodies having less rigidity than said rigid body. The less rigid bodies include a contact area for sealing contact with the gate in its closed position, and additional portions for being clamped between the first and second parts of the housing. The rigid body makes it possible to give the valve body almost any desired shape and size, without requiring stabilization through additional supporting arrangements. The additional portions may be clamped in a groove of the first and second housing parts, thereby providing sealing between the housing parts, and retaining and positioning the valve body in the housing. The additional portions are provided with holes for allowing bolts to pass for forcing the first and second housing parts together at clamping of the insert.

A drawback of the gate valve of U.S. Pat. No. 6,942,194B2 is that it under certain circumstances may leak, such as by large temperature variations. Further, it is cumbersome to assemble because of the many bolts used for forcing the first and second housing parts together at clamping of the valve body. Also, proper sealing is time consuming and requires correct momentum be applied to the bolts, which in turn requires special tools and assembly skills.

### SUMMARY

An object of the present invention is to provide an improved gate valve, which is easy to assemble without using special tools, and which is not prone to leaking at rapidly changing temperatures and varying internal and external pressures.

This and other objects are achieved by a gate valve as defined in claim 1.

The gate valve comprises a valve body provided with an inlet opening, an outlet opening and a fluid flow channel connecting the inlet and the outlet openings. The valve body further comprises a control body extending laterally to the fluid flow channel and having an outer opening. Also, the gate valve comprises a gate member movable within the control body back and forth through the outer opening, between an open position and a closed position, for controlling fluid flow through the flow channel. Further, the gate valve comprises a housing which comprises an inlet member, an outlet member, a top member, and a bottom member. The gate valve comprises three independent sealing zones for sealing between housing and valve body, wherein the first sealing zone is provided between the valve body and the top member, the second sealing zone is provided between the valve body and the inlet member, and the third sealing zone is provided between the valve body and the outlet member.

The independent sealing zones provide for improved sealing reliability, since each sealing zone has a gasket working independently of the other gaskets. Thus, deformation of a sealing zone, such as by temperature related expansion or contraction of housing, valve body and/or gasket, will not directly affect the sealing ability of other sealing zones.

In an embodiment, each sealing zone comprises a sealing surface provided on the valve body or on the respective housing member, and a respective gasket provided between the valve body and the respective housing member, the respective gaskets being removable or integrated with the gate valve.

The gasket presses against the sealing surface to prevent fluid leak between valve body and housing member. Further, the use of a gasket enables disassembly, service and re-use of the gate valve. The gaskets may be provided as separate parts, for example O-rings, or may be provided in the form of a flexible material molded onto the valve body or the respective housing member.

In an embodiment, each respective sealing surface is provided with an extended sealing portion configured such that the respective housing member is movable relative to the valve body with the gasket sliding along the extended sealing portion of the sealing surface.

The provision of such an extended sealing portion enables the gasket to slide over the surface to thereby prevent excessive buildup of internal stress in the gasket. This allows the gasket to seal properly, even if relative movement occurs between valve body and housing member, since the seal is not subject to sideways deformation. Hence, this improves reliability of the sealing functionality of each sealing zone.

In an embodiment, each respective extended sealing portion is circumferential. Thus, it is possible to seal all around the respective sealing zones, with one respective gasket. The extended sealing zone has a substantially uniform cross-sectional shape with respect to a respective central axis of each sealing zone.

The uniform shape may for example be cylindrical or otherwise tube-shaped. The uniform shape with respect to the longitudinal axis enables relative movement of the valve body and the respective sealing parts along the respective longitudinal axis, with the gasket following the extended sealing portion.

In an embodiment, two or more of the housing members are provided with locking means operable between an unlocked position in which the housing members are movable relative to each other such that they can be mounted on the valve body, and a locked position in which the locking means engage two or more housing members such that the at least two housing members cannot be moved apart.

Each housing part can thus be mounted to the valve body without using any bolts or special tools. Thereafter, the housing parts can be interlocked to form the housing. The housing is typically connected to incoming and outgoing pipes, and the housing transfers applied stress between its parts without stressing the valve body. The housing can thus be mounted on the valve body with each housing member independently sealed to the valve body, where after housing members are locked to each other by the locking means, such that the housing members together form the housing. Since the locking means does not directly affect each sealing zone, no bolts need be used to press housing parts together in order to achieve proper sealing, as with prior art gate valves.

In an embodiment, each respective sealing zone is configured such that the gaskets are compressed by press fit between the valve body and the respective housing member at mounting of the housing members onto and/or into the valve body, such that the gaskets seal.

The press-fit makes it possible to achieve sealing functionality in each sealing zone, without tensioning the housing parts towards the valve body, such as using screws and bolts. Hence, deformation of the gasket is determined at design-stage, and not by the person assembling the gate valve. Thus, sealing function is not dependent on tensioning of screws, bolts or similar to a specific torque.

In an embodiment, each sealing zone is provided with means for holding a the respective gasket in the respective sealing zone, the holding means comprising one or more protrusions, ridges or recesses provided on the valve body or on the respective housing member of each respective sealing zone.

The holding means enables use of a removable gasket, without risk of the gasket moving about during mounting of the housing members onto/into the valve body.

In an embodiment, the top member of the housing is provided with internal support means, such as one or more protrusion or recesses, configured to engage an upper portion of the control body when the top member is mounted to the valve body, to thereby prevent inwards movement of walls of the upper portion of the control body.

Controlling the movement of the walls of the upper portion of the control body to prevent inwards movement, prevents malfunction of the associated sealing zone due to external over pressure and subsequent deformation of the control body, thereby providing a more robust gate valve.

According to an aspect of the invention, a method is provided for assembly of a gate valve according to any one of the above mentioned embodiments. The method comprises the steps of: providing a gasket in each sealing zone, pressing the inlet and outlet members into/onto the valve body, subsequently pressing the top member onto the valve body, mounting the bottom member onto the rest of the housing, and locking the top and bottom members together.

Such an assembly method is advantageous, in that it is fast, convenient, and not relying on manual measures and skills, such as specific pre-tensioning of bolts using torque wrench.

### BRIEF DESCRIPTION OF DRAWINGS

FIGS. 1 and 1a show the prior art gate valve of U.S. Pat. No. 6,942,194B2.

FIG. 2 shows a gate valve according to a first embodiment of the present invention.

FIG. 2a shows an enlarged partial view of FIG. 2.

FIG. 3 shows an exploded view of the gate valve also shown in FIGS. 2 and 2a.

Table of reference numerals

| | |
|---|---|
| 1 | gate valve |
| 2 | valve body |
| 3 | inlet opening of valve body |
| 4 | outlet opening of valve body |
| 5 | fluid flow channel |
| 6 | control body |
| 7 | outer opening of control body |
| 8 | gate member |
| 9 | sealing surface by inlet opening |
| 10 | sealing surface by outlet opening |
| 11 | sealing surface by outer opening of control body |
| 12 | housing |
| 13 | inlet member of housing |
| 14 | outlet member of housing |
| 15 | top member of housing |
| 16 | bottom member of housing |
| 17 | sealing surface of top member |
| 18 | sealing surface of inlet member |
| 19 | sealing surface of outlet member |
| 20 | top gasket |
| 21 | inlet gasket |
| 22 | outlet gasket |
| 23 | first interlocking means |
| 24 | second interlocking means |
| 25 | third interlocking means |
| 26 | fourth interlocking means |
| 27 | locking means |
| 28 | holding means for gasket |
| 29 | first steering protrusion of gate member |
| 30 | second steering protrusion of gate member |
| 31 | locking pins |
| 32 | recesses of bottom member |
| 33 | protrusions of top member |
| 34 | slots |
| 38 | internal support means |
| P1 | extended sealing portion |
| P2 | extended sealing portion |
| P3 | extended sealing portion |
| A | sealing zone |
| B | sealing zone |
| C | sealing zone |
| a1 | central axis |
| a2 | central axis |
| a3 | central axis |

### DETAILED DESCRIPTION

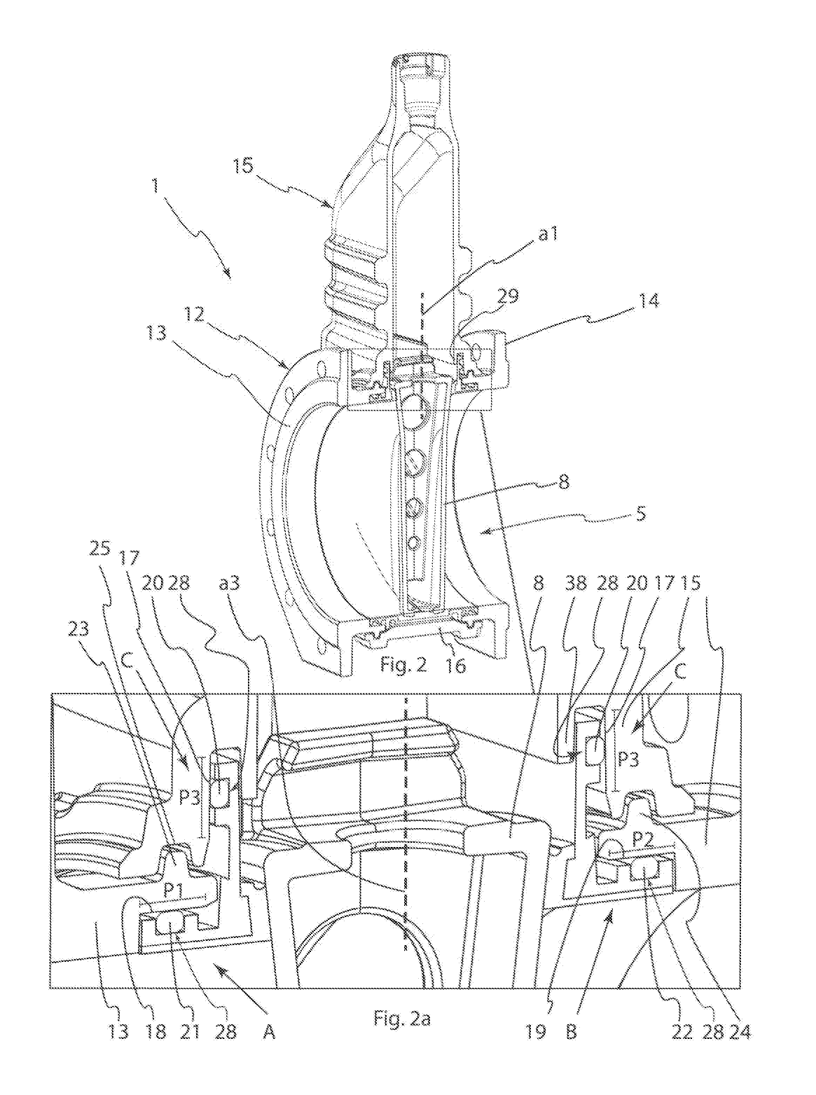

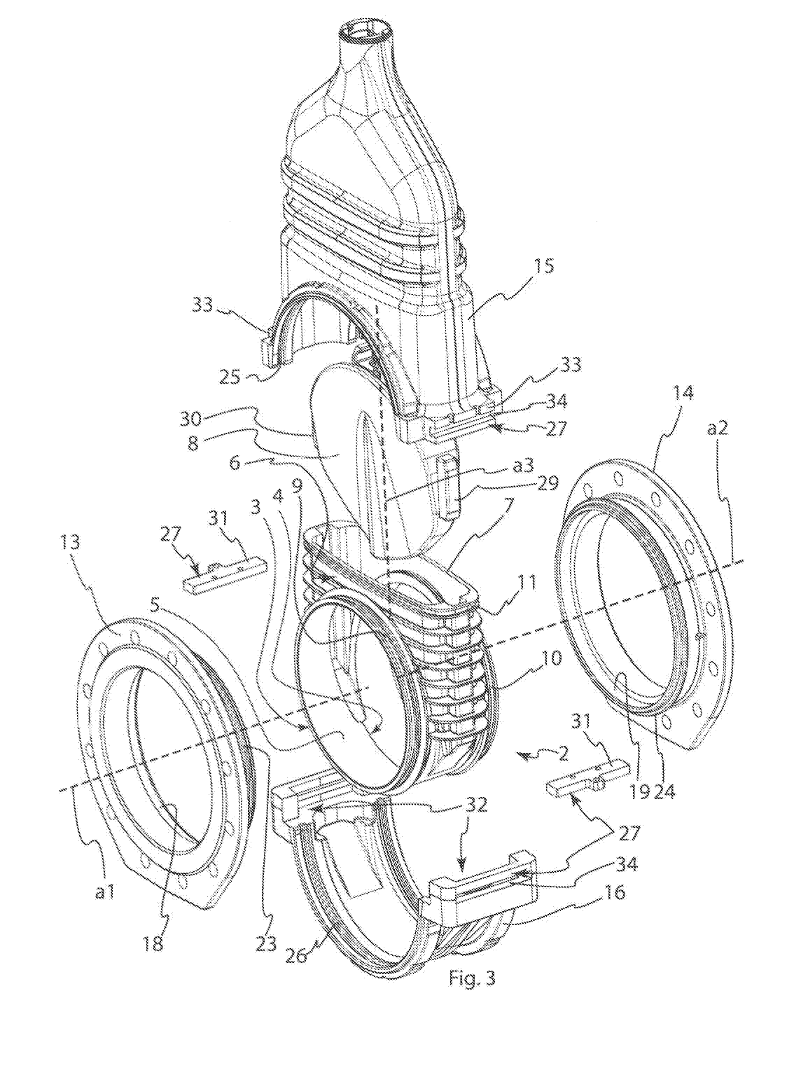

A first embodiment of the invention will hereinafter be described with reference to FIGS. 2, 2a and 3. The gate valve 1 according to the first embodiment of the invention comprises a valve body 2 provided with an inlet opening 3, an outlet opening 4. A fluid flow channel 5 connects the inlet 3 and the outlet 4 openings such that fluid can flow through the valve body. The fluid flow channel is substantially cylindrical. The valve body 2 comprises a body 6 called control body, which extends laterally to the cylindrical body forming the fluid flow channel 5. The fluid flow channel is open downwards into the control body. Further, the control body has an outer opening 7. The gate valve 1 comprises a gate member 8 movable within the control body 6 back and forth through the outer opening 7, between an upper open position and a lower closed position, for controlling fluid flow through the flow channel 5. In its closed position, the gate member 8 extends into the fluid flow channel 5 through the opening to the control body 6, such that the gate member 8 blocks fluid flow through the gate valve 1. The control body 6 is provided with opposite guiding recesses through which opposite first and second guiding protrusions 29, 30 of the gate member 8 slide at opening and closing of the gate valve 1.

A suitable material for the valve body is POM, being a rather rigid material. In certain embodiments, various portions of the valve body 2 comprise a softer material, such as EPDM. The softer material could be molded onto a more rigid component of the valve body. Of course, as the skilled person would understand, the valve body can comprise other suitable materials than POM and/or EPDM. Various aspects of a two-material valve body is discussed in the cited prior art document U.S. Pat. No. 6,942,194B2.

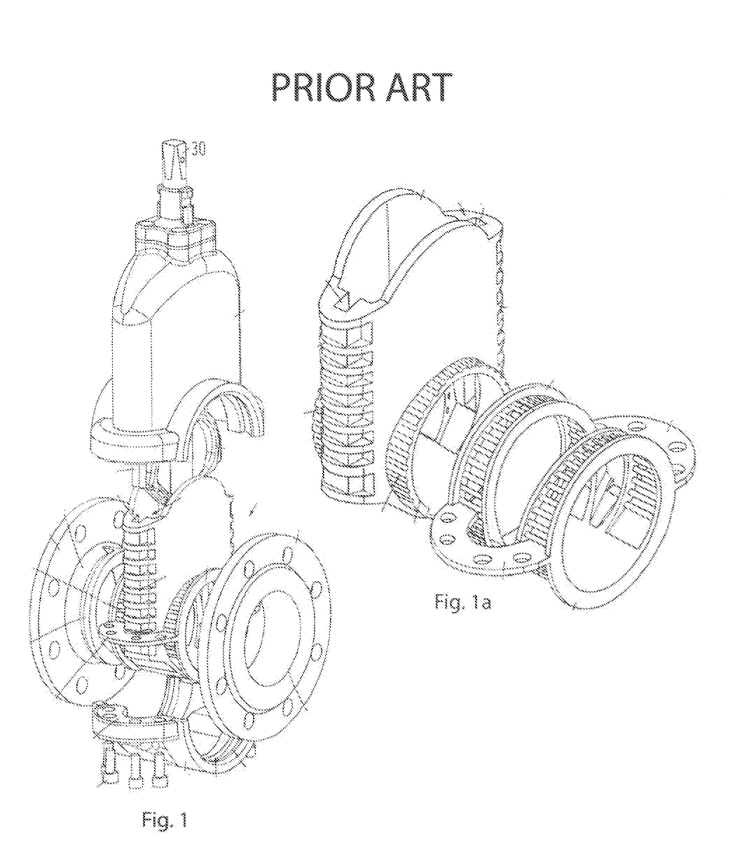

According to the first embodiment of the present invention, the gate valve 1 further comprises a housing 12 comprising an inlet member 13 an outlet member 14, a top member 15, and a bottom member 16. The gate valve comprises three independent sealing zones A, B, C for sealing between housing 12 and valve body 2. The first sealing zone is provided between the valve body 2 and the top member 15, the second sealing zone is provided between the valve body 2 and the inlet member 13, and the third sealing zone is provided between the valve body 2 and the outlet member 14. The housing is made of cast iron, although the skilled person would understand that other suitable materials could be used instead in other embodiments. A difference between the gate valve 1 of the present invention and the gate valve of the cited prior art document U.S. Pat. No. 6,942,194B2, is that the gate valve 1 of the invention has independent sealing zones, whereas the one of U.S. Pat. No. 6,942,194B2 has a continuous gasket in the form of EPDM molded onto the valve body bridging the sealing zones, as shown in FIG. 1a. Further, the prior art use of bolts for clamping the EPDM part strengthens dependency between the sealing zones of U.S. Pat. No. 6,942,194B2, in a way which the inventors have found to sometimes be disadvantageous. Instead, the present invention realizes that independent sealing zones provide for improved sealing reliability, since each sealing zone has a gasket working independently of the other gaskets. Thus, deformation of a sealing zone, such as by temperature related expansion or contraction, will not directly affect the sealing ability of other sealing zones.

Each sealing zone comprises a sealing surface provided on the valve body 2 or on the respective housing member 13, 14, 15, and a respective gasket in the form of an O-ring provided between the valve body 2 and the respective housing member 13, 14, 15. Although O-rings are used in the present embodiment, the gasket may take other forms in other embodiments, such as a gasket with non-circular cross-section, a gasket molded onto separate portions of the valve body 2 and/or the respective inlet 13, outlet 14 or top 15 housing members. An advantage of using O-rings is that they are readily available, such that they can easily be exchanged at service, without having to replace the valve body or fly in spare parts.

Each respective sealing surface 17, 18, 19 is provided with an extended sealing portion P1, P2, P3 configured such that the respective housing member 13, 14, 15 is movable relative to the valve body 2 with the gasket sliding along the extended sealing portion of the sealing surface.

That said, the term ‘extended sealing portion’ within the context of the present invention means that the extended sealing portion provides more sealing surface than the minimum surface needed for static sealing using the gasket of choice. Hence, the extended area provided with the inventive extended sealing portion, enables the gasket so slide over the sealing surface and still seal, thereby allowing certain relative movement and deformation between valve body and housing members of each respective sealing zone.

Some prior art gate valves, leak due to relative movement and deformation between valve body and housing members, such as at large temperature variations.

In the present embodiment, the sealing surfaces are provided on the inlet, outlet and top members of the housing, wherein the O-rings are provided in respective circumferential recesses around the inlet opening 3, outlet opening 4 and outer opening 7 of the valve body 2, as shown in FIG. 2a. It should be understood that the sealing surfaces could just as well be provided on the valve body, wherein the gasket would be provided loose in each sealing zone, or positioned in a recess or other holding means on the respective inlet, outlet or top housing member. The sealing surfaces of the present embodiment are provided on radially inner circumferences of the respective housing members 13, 14, 15, but could in other embodiments just as well be provided on radially outer circumferences, as long as the valve body is correspondingly configured; for example by arranging the O-rings in radially inner recesses in the valve body 2.

Each respective extended sealing portion has a substantially cylindrical shape connecting to a chamfered outer opening. The chamfered portion functions to lead the O-ring, or other gasket, into the cylindrical extended sealing portion.

The top 15 and bottom 16 housing members are provided with interlocking means in the form of two recesses 32 provided on opposite sides of the bottom member, and matching protrusions 33 provided on opposite sides of the top member 15. When the top 15 and bottom 16 members are mounted on the valve body 2, the protrusions 33 of the top member 15 extend into the recesses 32 of the bottom member 16. The interlocking means further comprises a respective locking pin 31, or similar, which is insertable through aligned slots in the respective recesses 32 and protrusions 33 of the top 15 and bottom 16 members, such that the pin 31 engages both slots and prevents the top 15 and bottom 16 members from being moved apart. In order to once again enable the top 15 and bottom 16 members to be dismounted from the valve body 2, the pins 31 are simply withdrawn from the slots, by grabbing hold of gripping ears protruding from the pins outside the housing 12. The protrusions and recesses of the interlocking means are such configured, that they only allow freedom of movement in the mounting/dismounting directions, and prevent sideways relative movement. This provided for a more robust interlock between top and bottom members.

The inlet 13 and outlet 14 members are provided with first 23 and second 24 interlocking means, in the form of radially outer circumferential ridges, for engaging corresponding third 25 and fourth 26 interlocking means of the top 15 and bottom 16 members, in the form of semi-circular inner recesses. In order to mount the housing members top form the housing 12, the inlet 13 and outlet 14 members are first slid onto the valve body 2, where after the top and bottom members are mounted. Finally, the locking means is engaged by pushing in the pins 31 into the recesses 33, 34.

Each housing part can thus be mounted to the valve body without using any bolts or special tools. Thereafter, the housing parts can be interlocked to form the housing.

Each respective sealing zone A, B, C is configured such that the gaskets 20, 21, 22 are compressed by press fit between the valve body 2 and the respective housing member 13, 14, 15 at mounting of the housing members 13, 14, 15 onto and/or into the valve body 2. The press-fit being such that enough pressure occurs on the gasket for ensuring good sealing without further pressurizing of the gasket. Thus, sealing function is not dependent on tensioning of screws, bolts or similar to a specific torque. Also, the valve can be quickly assembled, since no bolts have to be mounted.

Each sealing zone is provided with means 28 for holding a the respective gasket 20, 21, 22 in the respective sealing zone A, B, C. In this embodiment, the holding means 28 comprises a respective circumferential recess around each respective sealing zone of the valve body 2, said recess being dimensioned to fit with the O-ring of choice such that the O-ring cannot move relative the valve body along the respective longitudinal axis a1, a2, a3 of the respective sealing zone A, B, C.

The top member 15 of the housing 12 is provided with internal support means 38 in the form of opposite protrusions configured to engage an upper portion of the control body 6 when the top member 15 is mounted on the valve body 2, to thereby prevent inwards movement of walls of the upper portion of the control body 6. In other embodiments, the engagement between the upper portion of the control body 6 and the top member 15, could be provided by other combinations of mutually engaging formations provided on the two parts, such as protrusions on the control body and corresponding recesses on the inside of the top member 15. Controlling the movement of the walls of the upper portion of the control body to prevent inwards movement, prevents malfunction of the associated sealing zone due to external over pressure and subsequent deformation of the control body, thereby providing for a more robust gate valve.

Lastly, the present invention teaches a fast and reliable method of mounting and dismounting a gate valve according to the invention The method of comprises the steps of: providing a gasket in each sealing zone, pressing the inlet and outlet members into/onto the valve body 2, subsequently pressing the top member onto the valve body and mounting the bottom member onto the rest of the housing, and finally locking the top and bottom members together using the locking means 27, or any auxiliary locking means capable of preventing relative movement of the housing parts after they are mounted on the valve body.

The method is advantageous, in that it is fast, convenient, and not relying on manual measures and skills, such as specific pre-tensioning of bolts using torque wrench.

1. A gate valve comprising:
a valve body comprising:
an inlet opening,
an outlet opening,
a fluid flow channel connecting the inlet and the outlet openings, and
a control body extending laterally to the fluid flow channel and including an outer opening;
a gate member movable within the control body back and forth through the outer opening, between an open position and a closed position, for controlling fluid flow through the flow channel;
comprising housing members, the housing members comprising an inlet member, an outlet member, a top member, and a bottom member;
three independent sealing zones for sealing between the housing and the valve body;
wherein a first sealing zone of the three independent sealing zones is provided between the valve body and the top member, a second sealing zone of the three independent sealing zones is provided between the valve body and the inlet member, and third sealing zone of the three independent sealing zones is provided between the valve body and the outlet member.

2. The gate valve of claim 1, wherein each sealing zone comprises a sealing surface provided on the valve body or on the housing member, and a gasket provided between the valve body and the housing member, the gaskets being removable or integrated with the gate valve.

3. The gate valve of claim 2, wherein each sealing surface is provided with an extended sealing portion configured such that the housing member is movable relative to the valve body with the gasket slidable along the extended sealing portion of the sealing surface.

4. The gate valve of claim 3, wherein each extended sealing portion is circumferential and has a substantially uniform cross-sectional shape with respect to a central axis of each sealing zone.

5. The gate valve of claim 1, wherein two of the housing members are provided with locking means operable between an unlocked position, in which the housing members are movable relative to each other to be mounted on the valve body, and a locked position in which the locking means engage the two or more housing members such that the two or more housing members are not movable apart.

6. The gate valve of claim 2, wherein each sealing zone is configured such that the gaskets are compressed by press fit between the valve body and the housing member at a mounting of the housing member onto or into the valve body.

7. The gate valve of claim 2, wherein each sealing zone is provided with holding means for holding the respective gasket in the respective sealing zone, the holding means comprising a protrusion, ridge, or recess provided on the valve body or on the respective housing member of each respective sealing zone.

8. The gate valve of claim 1, wherein the top member of the housing is provided with internal support means comprising a protrusion or recess configured to engage an upper portion of the control body when the top member is mounted to the valve body to prevent movement of walls of the upper portion of the control body.

9. A method of assembling a gate valve comprising:
providing gaskets in to form sealing zones between a housing and a valve body of the gate valve, the housing comprising an inlet member, an outlet member, a top member, and a bottom member;
pressing the inlet and outlet members into or onto the valve body;
pressing the top member onto the valve body;
mounting the bottom member onto the housing; and
locking the top and bottom members together.
